(19) United States
(12) Patent Application Publication
(10) Pub. No.: US 2011/0135827 A1
(43) Pub. Date: Jun. 9, 2011

(54) METHOD OF FABRICATING CARBON NANOTUBES UNIFORMLY COATED WITH TITANIUM DIOXIDE

(75) Inventors: Ki-Chul Kim, Daejeon-city (KR); Sung-Lyul Maeng, Chungcheongbuk-do (KR); Sang-Hyeob Kim, Daejeon-city (KR); Rae-Man Park, Daejeon-city (KR); Jong-Hyurk Park, Daegu-city (KR); Young-Jin Choi, Seoul (KR); Dae-Joon Kang, Jeju-city (KR)

(73) Assignee: Electronic and Telecommunications Research Institute, Daejeon-city (KR)

(21) Appl. No.: 12/531,965

(22) PCT Filed: Mar. 19, 2008
(86) PCT No.: PCT/KR2008/001549

§ 371 Date: Mar. 18, 2010

(30) Foreign Application Priority Data
Mar. 19, 2007 (KR) 1020070026775

(51) Int. Cl. B05D 5/00; B05D 3/10; B05D 3/02; B05D 3/12; B82Y 40/00; B82Y 99/00

(52) U.S. Cl. 427/310; 427/299; 977/750; 977/752; 977/892

(57) ABSTRACT

Provided is CNTs on which TiO₂ is uniformly coated. The method includes: functionalizing CNTs with hydrophilic functional groups; mixing the CNTs functionalized with hydrophilic functional groups in a solution that contains with TiO₂ precursors; refining TiO₂ precursor-coated CNTs from the solution in which the CNTs and the TiO₂ precursors are mixed; and heat treating the refined TiO₂-coated CNTs. The TiO₂-coated CNTs formed in this manner simultaneously retain the characteristics of CNTs and TiO₂ nanowires, and thus, can be applied to solar cells, field emission display devices, gas sensors, or optical catalysts.

### TECHNICAL FIELD

The present invention relates to carbon nanotubes (CNTs) coated with a functional oxide and a method of fabricating the CNTs coated with a functional oxide.

The present invention was supported by the Information Technology (IT) Research & Development (R & D) program of the Ministry of Information and Communication (MIC) [project No. 2005-S-605-02, project title: IT-BT-NT Convergent Core Technology for advanced Optoelectronic Devices and Smart Bio/Chemical Sensors].

### BACKGROUND ART

CNTs are macromolecules having a hollow cylindrical shape with a nano size diameter, and are formed by rolling graphite faces having a hexagonal honeycomb shape in which one carbon atom combines with three other carbon atoms. CNTs have unique physical properties, for example, they are light, have electrical conductivity as high as copper, have thermal conductivity as high as diamond, and have tensile strength compatible to steel. CNTs can control electrical properties of metals or semiconductors according to their diameter and wounding shape although they are not doped with a dopant. CNTs can be classified into single walled nanotubes (SWNTs) and multi-walled nanotubes (MWNTs) according to rolled shape, and a shape of CNTs in which SWNTs are bundled is referred to as a rope nanotube.

Since CNTs have various physical properties, CNTs can be used as electron emitters, vacuum fluorescent displays (VFDs), field emission displays (FEDs), lithium ion secondary cell electrodes, hydrogen storage fuel cells, nanowires, nano capsules, nano pincettes, AFM/STM tips, single electron transistors, gas sensors, minute parts for medical and technical fields, and high functional composites, etc.

In particular, many studies have been conducted regarding functional CNTs coated with a particular material. Representative examples of such studies are a characteristic study on a high performance field-emission device using CNTs on which a material such as SiO₂ or MgO having wide band gap (Whikun Yi et al., Adv. Mater. 14, 1464-1468, 2002) is coated and a study on a field effect transistor including CNTs on which alumina is coated (Lei Fu et al., Adv. Mater. 18, 181-185, 2006).

Meanwhile, nano scale TiO₂ is a material widely used as an optical catalyst for environmental purification, a dissolving agent for poisonous organic contaminants, dye sensitive solar cells, and gas sensors and various manufacturing methods have been studied. Representative examples of such studies are a study on sol-gel electrophoresis (Y. Lin et al., J. Phys.: Condens. Matter. 15, 2917-2922, 2003), a study on physical vapour deposition (B. Xiang et al., J. Phys. D: Appl. Phys., 38, 1152-1155, 2005), and a study on thermal evaporation (Jyh-Ming Wu et al., Nanotechnology, 17, 105-109, 2006).

However, TiO₂-coated CNTs and a method of fabricating the TiO₂-coated CNTs have not yet been reported.

### DISCLOSURE OF INVENTION

### Technical Problem

To address the above and/or other problems, the present invention provides CNTs on which TiO₂ is uniformly coated so that the CNTs have both physical characteristics of TiO₂ nanowire and physical characteristics of CNTs. Such CNTs can be applied to solar cells, field emission display devices, gas sensors, and optical catalysts etc.

### Technical Solution

According to an aspect of the present invention, there is provided a method of fabricating TiO₂-coated carbon nanotubes (TiO₂-coated CNTs), comprising: functionalizing CNTs with hydrophilic functional groups; mixing the CNTs functionalized with hydrophilic functional groups in a solution that contains with TiO₂ precursors; refining TiO₂ precursor-coated CNTs from the solution in which the CNTs and the TiO₂ precursors are mixed; and heat treating the refined TiO₂-coated CNTs.

The CNTs may be single-walled nanotubes (SWNTs) or multi-walled nanotubes (MWNTs) on which TiO₂ precursors are coated.

The functionalizing of CNTs with hydrophilic functional groups may comprise functionalizing the CNTs with carboxyl groups. At this point, the functionalizing of the CNTs with carboxyl groups may comprise refluxing the CNTs in a mixture of sulfuric acid and nitric acid.

The TiO₂ precursors may be formed by hydrolysis of a mixed solution in which a titanium alkoxide and alcohol are mixed. At this point, the titanium alkoxide may be titanium n-butoxide Ti[O(CH₂)₃CH₃]₄ and the alcohol may be methyl alcohol. The mixed solution of the titanium alkoxide and the alcohol may further comprise a stabilizer, and the stabilizer may be benzoylacetone. The titanium n-butoxide and the benzoylacetone may be mixed in a molar ratio of 1:1.

The TiO₂ precursors are refined to remove large particles of TiO₂ precursors by filtering the mixed solution in which a titanium alkoxide and alcohol are mixed. The concentration of TiO₂ may be controlled using alcohol when the TiO₂ precursors are refined.

The mixing of the CNTs functionalized with hydrophilic functional groups in a solution that contains with TiO₂ precursors may further comprise performing ultra-sonication of the mixed solution. The ultrasonication may be performed for 12 to 24 hours.

The refining of TiO₂ precursor-coated CNTs may comprise filtering the mixed solution using a filter paper, and may further comprise drying the TiO₂-coated CNTs in the air after refining the TiO₂-coated CNTs using a filter paper.

In the mixing of the CNTs functionalized with hydrophilic functional groups in a solution that contains TiO₂ precursors, the CNTs functionalized with hydrophilic functional groups may be mixed in the solution that contains refined TiO₂ precursors in a mixing concentration (kg/1) in the range of 0.005% to 0.015%.

The heat treating of the refined TiO₂-coated CNTs may be performed at a temperature in the range of 300° C. to 700° C.

### Advantageous Effects

As described above, CNTs are functionalized with hydrophilic carboxyl groups, TiO₂ precursors are synthesized, the TiO₂ precursors and the CNTs are mixed, and then, CNTs on which the TiO₂ precursors are coated (TiO₂-coated CNTs) are formed by ultrasonification and heat treating. The TiO₂-coated CNTs formed in this manner have both the characteristics of CNTs and TiO₂ nanowires, and thus, can have wide industrial applicability such as solar cells, field emission display devices, gas sensors, or optical catalysts.

### DESCRIPTION OF DRAWINGS

The above and other features and advantages of the present invention will become more apparent by describing in detail exemplary embodiments thereof with reference to the attached drawings in which:

FIGS. 1A through 1G are schematic plots for explaining a method of fabricating CNTs on which TiO₂ is uniformly coated (TiO₂-CNTs), according to an embodiment of the present invention;

FIG. 2 is a graph showing an X-ray diffraction pattern of TiO₂-CNTs fabricated according to an embodiment of the present invention;

FIG. 3 is a graph showing a Raman spectroscopy of TiO₂-CNTs fabricated according to an embodiment of the present invention;

FIG. 4 is a graph showing a Raman spectroscopy for assuring the stability of a solution of CNTs on which TiO₂ precursor is uniformly coated;

FIG. 5 is a transmission electron microscopic (TEM) image of TiO₂-CNTs fabricated according to an embodiment of the present invention; and

FIG. 6 is a scanning electron microscopic (SEM) image of CNTs which are mixed with TiO₂ precursors by ultrasonication, however, a refining process using a filter paper is omitted.

### BEST MODE

According to the present invention, a method of fabricating TiO₂-coated carbon nanotubes (TiO₂-coated CNTs) includes, functionalizing CNTs with hydrophilic functional groups, mixing the CNTs functionalized with hydrophilic functional groups in a solution that contains with TiO₂ precursors, refining TiO₂ precursor-coated CNTs from the solution in which the CNTs and the TiO₂ precursors are mixed, and heat treating the refined TiO₂-coated CNTs.

### Mode for Invention

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the following descriptions, it is understood that when a layer is referred to as being ‘on’ another layer or substrate, it can be directly on the other constituent element, or intervening a third constituent element may also be present. Also, in the drawings, the thicknesses of layers and regions are exaggerated for clarity, and like reference numerals in the drawings denote like elements. Terms used in the descriptions are to explain the present invention, and do not confine the meanings and the range of the present invention.

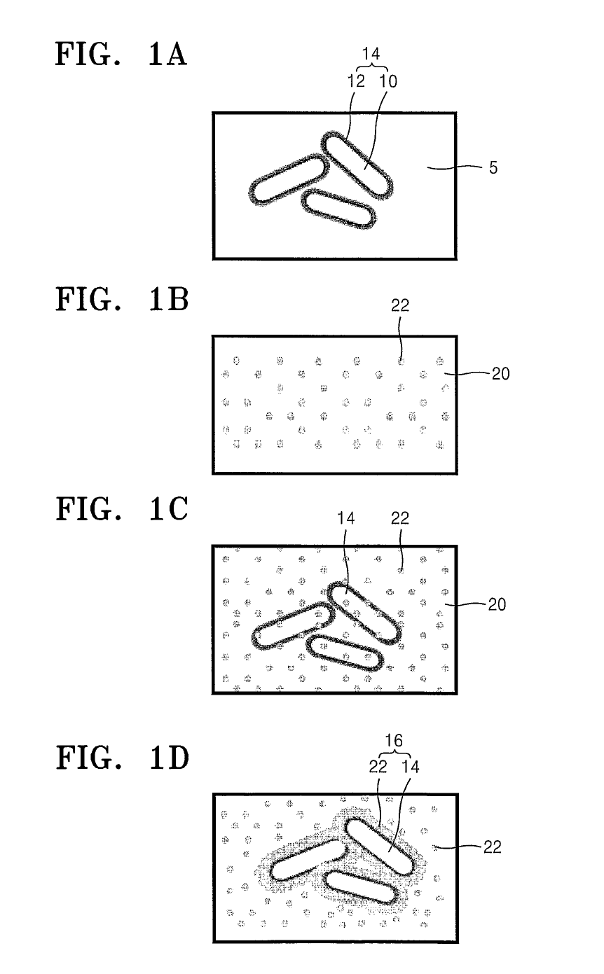

FIGS. 1A through 1G are schematic plots for explaining a method of fabricating CNTs on which TiO₂ is uniformly coated (TiO₂-CNTs), according to an embodiment of the present invention.

Referring to FIG. 1A, carbon nanotubes (CNTs) 10 are functionalized with a hydrophilic group. The CNTs 10 can be formed using electric discharge, laser deposition, plasma enhanced chemical vapor deposition (PECVD), thermal chemical vapor deposition, or electrolysis/flame synthesis. At this point, the CNTs 10 can be single walled nanotubes (SWNT) or multi-walled nanotubes (MWCNT). The CNTs 10 may have a diameter of a few to a few tens of nm and a length of a few tens of μm. CNTs 14 functionalized with a hydrophilic group can be formed by forming carboxyl groups 12 on surfaces of the CNTs 10 through refluxing the CNTs 10 in a solution 5 of sulfuric acid and nitric acid.

Referring to FIG. 1B, separately from the CNTs 10, TiO₂ precursors 22 are formed by hydrolyzingtitanium n-butoxideTi[O(CH₂)₃CH₃]₄ in an alcohol solution 20 at room temperature. The TiO₂ precursors 22 according to the present embodiment are formed by hydrolyzing titanium n-butoxide in alcohol and form CNTs on which TiO₂ is coated (TiO₂-CNTs) by heat treating after the TiO₂ precursors are coated on CNTs. The alcohol solution 20 can be methyl alcohol, and benzoylacetone can be used as a stabilizer. At this point, titanium n-butoxide is mixed with benzoylacetone in a molar ratio of 1:1 for 2 hours. After controlling the amount of alcohol solution 20 so that the weight concentration of the TiO₂ precursors 22 can be 4.25% in the alcohol solution 20, the alcohol solution 20 is filtered using a 20 nm filter to remain the TiO₂ precursors 22 having small particle sizes in the alcohol solution 20.

Referring to FIGS. 1C and 1D, after mixing the CNTs 14 functionalized with carboxyl groups 12 in the alcohol solution 20 that contains TiO₂ precursors 22 to a concentration (kg/1) in the range of 0.005% to 0.015%, for example 0.009%, the mixture is ultrasonicated for 12 to 24 hours. Thus, the TiO₂ precursors 22 are uniformly coated on the CNTs 14 functionalized with carboxyl groups 12. The alcohol solution 20 that contains CNTs 16 on which the TiO₂ precursors 22 are uniformly coated is stabilized, and thus, no precipitation is generated even for a few weeks.

Referring to FIGS. 1E and 1F, the alcohol solution 20 that contains CNTs 16 on which the TiO₂ precursors 22 are uniformly coated is slowly filtered using a 200 nm filter, and then, is dried at a temperature of 90° C. in air.

Referring to FIG. 1G, in order to prevent the agglomeration of powder of the CNTs 16 on which the TiO₂ precursors 22 are uniformly coated, the CNTs 16 is dispersed in a solvent such as alcohol. Afterwards, the CNTs 16 dispersed in the solvent are coated on a silicon substrate or a copper grid using, for example, a spin coating method, and then heat treated for approximately 10 hours at a temperature in the range of 300° C. to 700° C., for example 500° C., in air. In this way, CNTs on which the TiO₂ precursors 22 are uniformly coated (hereinafter, TiO₂-coated CNTs 16′) are obtained

In the present embodiment, TiO₂-coated CNTs coated on a silicon substrate or a copper grid are obtained, however, in another embodiment of the present invention, the alcohol solution 20 that contains the TiO₂-coated CNTs 16′ is dried and heat treated at a temperature in the range of 300° C. to 700° C., for example 500° C. for approximately 10 hours, and thus, the powder TiO₂-coated CNTs are obtained.

X-Ray Diffraction Analysis

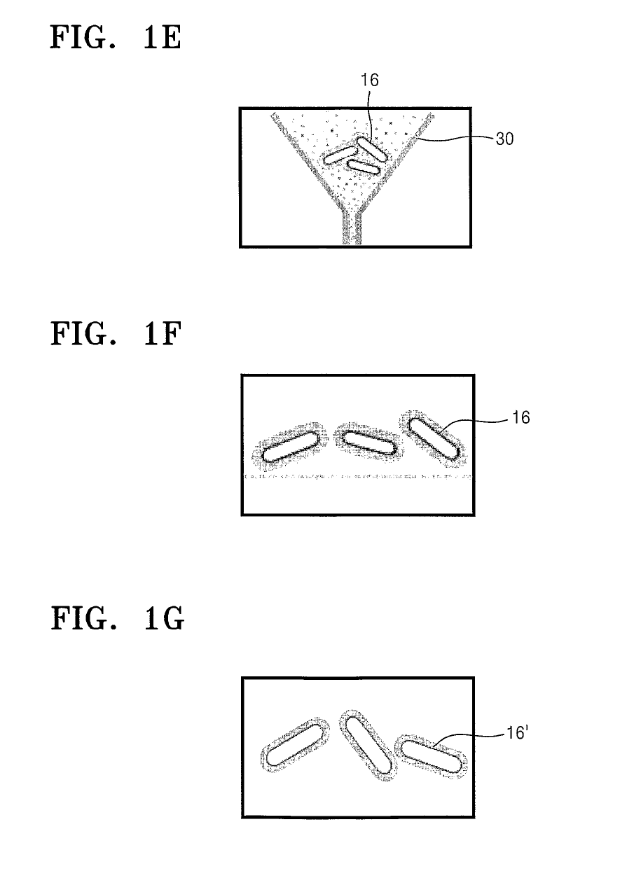

FIG. 2 is a graph showing an X-ray diffraction (XRD) pattern of TiO₂-coated CNTs fabricated according to an embodiment of the present invention. As described above, after the TiO₂-coated CNTs 16′ coated on a silicon substrate are heat treated, an XRD pattern was measured. As depicted in FIG. 2, diffraction peaks at an angle of 2θcorresponding to (101), (004), (200), (105), and (204) of TiO₂ were measured together with peaks of the silicon substrate. The peaks of the TiO₂-coated CNTs 16′ are in accordance with the peaks of an XRD pattern of a standard TiO₂ powder. That is, various faces of TiO₂ are observed. From this result, it can be seen that TiO₂ uniformly coated on CNTs has poly crystalline without orientation.

Raman Spectroscopy Analysis

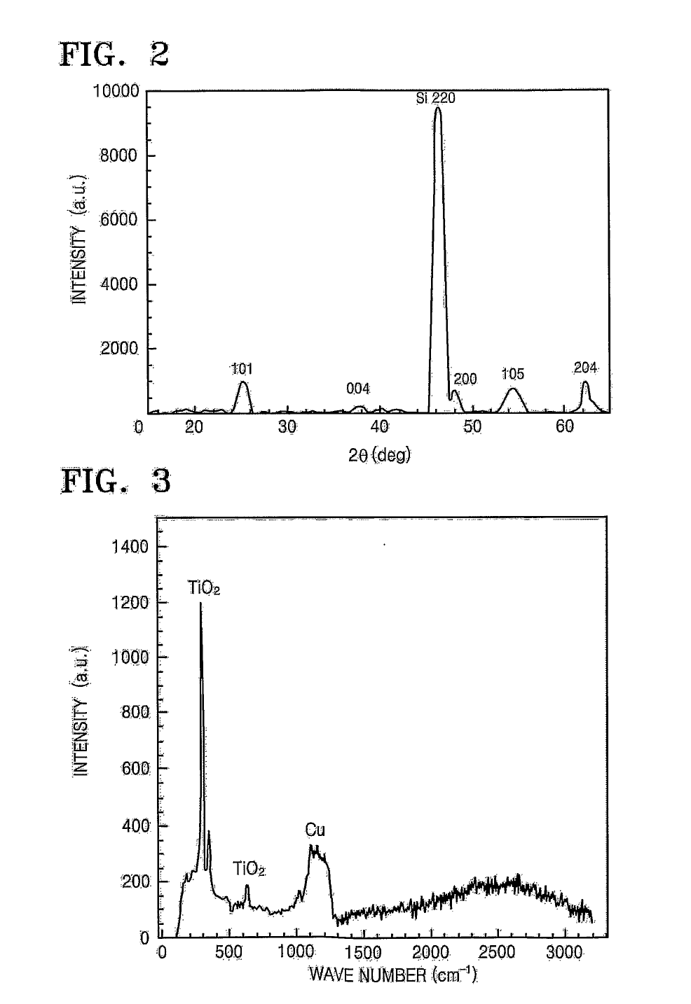

FIG. 3 is a graph showing a Raman spectroscopy of TiO₂-coated CNTs fabricated according to an embodiment of the present invention. As described above, after the TiO₂ coated CNTs are coated on a surface of a copper grid substrate and are heat treated, a Raman analysis was performed using a He—Ne laser of 527 nm and 50 mW. As a result, as shown in FIG. 3, it can be confirmed that peaks are shown at wave numbers corresponding to TiO₂. In the Raman spectrum of FIG. 3, no peaks related to other materials except TiO₂ and copper are observed, and this tells that, there is only a single phase of TiO₂. That is, only TiO₂ is coated on CNTs.

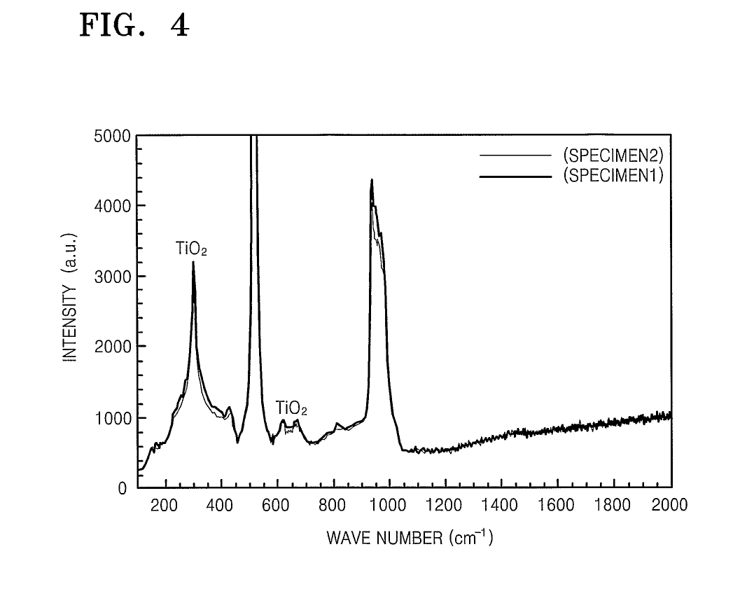

Also, in order to confirm the stability of a TiO₂-coated CNT solution (a solution in which TiO₂ precursors are uniformly coated on surfaces of CNTs), Raman spectroscopic analyses were performed with respect to a synthesized solution (specimen 1) that was aged for 22 days from the operation 1d and a synthesized solution (specimen 2) that was aged for 1 day. As described in the above embodiment, the specimens 1 and 2 were formed in thin films after coating on silicon substrates and heat treating them. The result of Raman spectroscopic analyses were shown in FIG. 4. As shown in FIG. 4, the synthesized solutions aged for different times from each other show identical Raman spectroscopic analyses having TiO₂ peaks. Thus, it can be seen that a solution that contains CNTs on which TiO₂ precursors are uniformly coated is very stable in air. Peaks, other than the TiO₂ peaks, shown in approximately 500 cm⁻¹ and 950 cm⁻¹ are caused from the silicon substrate.

Transmission Electron Microscopic (TEM) Analysis

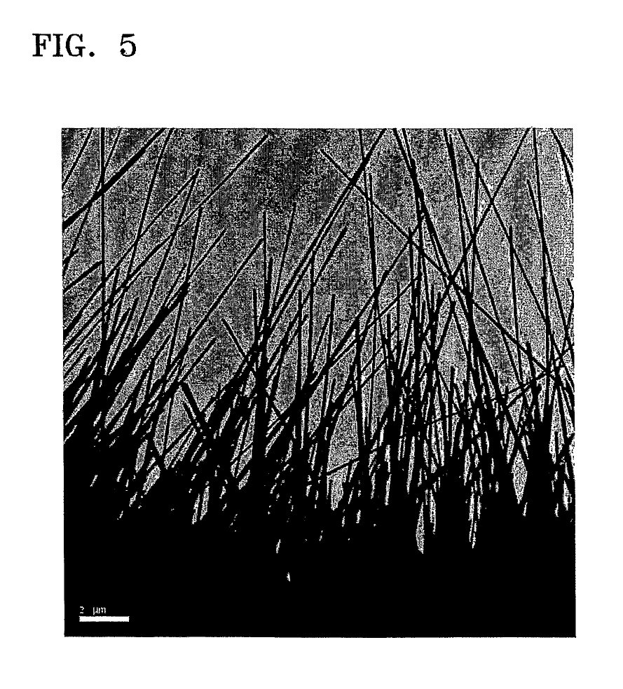

FIG. 5 is a TEM image of TiO₂-coated CNTs fabricated according to an embodiment of the present invention. As described above, TiO₂-coated CNTs are coated on a copper lattice substrate and are heat treated. The copper lattice substrate was used instead of a silicon substrate in order to readily take a TEM image. As shown in the TEM image of FIG. 5, carbon nanotubes have neat bar shapes. From this result, it can be seen that TiO₂ is uniformly coated on surfaces of CNTs. The CNTs on which TiO₂ is coated have a diameter of approximately 50 nm.

Scanning Electron Microscopic (SEM) Analysis

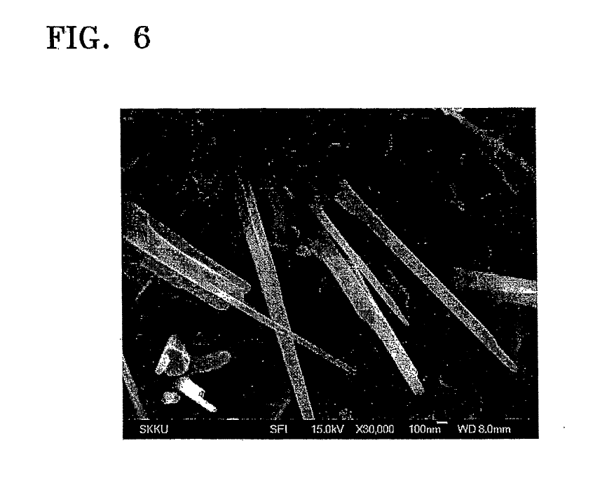

Various process variables were controlled in order to synthesize CNTs on which TiO₂ is uniformly coated. In each process, a product of TiO₂-coated CNTs was observed using a SEM. FIG. 6 is a SEM image of CNTs which are mixed with TiO₂ precursors by ultrasonication, however, a refining process using a filter paper is omitted. In the SEM image of FIG. 6, elongated carbon nanotubes have different diameters from each other. That is, it can be seen that, if a refining process using a filter paper is omitted, TiO₂ precursors are non-uniformly coated or agglomerated.

As described above, CNTs are functionalized with hydrophilic carboxyl groups, TiO₂ precursors are synthesized, the TiO₂ precursors and the CNTs are mixed, and then, CNTs on which the TiO₂ precursors are coated (TiO₂-coated CNTs) are formed by ultrasonification and heat treating. The TiO₂-coated CNTs formed in this manner have both the characteristics of CNTs and TiO₂ nanowires, and thus, can have wide industrial applicability such as solar cells, field emission display devices, gas sensors, or optical catalysts.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of fabricating TiO₂-coated carbon nanotubes (TiO₂-coated CNTs), comprising:
functionalizing CNTs with hydrophilic functional groups;
mixing the CNTs functionalized with hydrophilic functional groups in a solution that contains with TiO₂ precursors;
refining TiO₂ precursor-coated CNTs from the solution in which the CNTs and the TiO₂ precursors are mixed; and
heat treating the refined TiO₂-coated CNTs.

2. The method of claim 1, wherein the CNTs are single-walled nanotubes (SWNTs) on which TiO₂ precursors are coated.

3. The method of claim 1, wherein the CNTs are multi-walled nanotubes (MWNTs) on which TiO₂ precursors are coated.

4. The method of claim 1, wherein the functionalizing of CNTs with hydrophilic functional groups comprises functionalizing the CNTs with carboxyl groups.

5. The method of claim 1, wherein the functionalizing of the CNTs with carboxyl groups comprises refluxing the CNTs in a mixture of sulfuric acid and nitric acid.

6. The method of claim 1, wherein the TiO₂ precursors are formed by hydrolysis of a mixed solution in which a titanium alkoxide and alcohol are mixed.

7. The method of claim 6, wherein the titanium alkoxide comprises titanium n-butoxide Ti[O(CH₂)₃CH₃]₄.

8. The method of claim 6, wherein the alcohol comprises methyl alcohol.

9. The method of claim 6, wherein the mixed solution of the titanium alkoxide and the alcohol further comprises a stabilizer.

10. The method of claim 9, wherein the stabilizer comprises benzoylacetone.

11. The method of claim 10, wherein the titanium n-butoxide and the benzoylacetone are mixed in a molar ratio of 1:1.

12. The method of claim 6, wherein the solution containing TiO₂ precursor is refined by filtered to remove large particles of TiO₂ precursors in which a titanium alkoxide and alcohol are mixed.

13. The method of claim 11, wherein the concentration of TiO₂ is controlled using alcohol when the TiO₂ precursors are refined.

14. The method of claim 1, wherein the mixing of the CNTs functionalized with hydrophilic functional groups in a solution that contains with TiO₂ precursors further comprises performing ultrasonication of the mixed solution.

15. The method of claim 14, wherein the ultrasonication is performed for 12 to 24 hours.

16. The method of claim 1, wherein the refining of TiO₂ precursor-coated CNTs comprises filtering the mixed solution using a filter paper.

17. The method of claim 16, further comprising drying the TiO₂-coated CNTs in the air after refining the TiO₂-coated CNTs using a filter paper.

18. The method of claim 1, wherein, in the mixing of the CNTs functionalized with hydrophilic functional groups in a solution that contains TiO₂ precursors, the CNTs functionalized with hydrophilic functional groups are mixed in the solution that contains the TiO₂ precursors in a mixing concentration ratio in the range of 0.005% to 0.015%.

19. The method of claim 1, wherein the heat treating of the refined TiO₂-coated CNTs is performed at a temperature in the range of 300° C. to 700° C.
